(19) United States
(12) Patent Application Publication
(10) Pub. No.: US 2004/0179631 A1
(43) Pub. Date: Sep. 16, 2004

(54) UWB receiver architecture

(75) Inventor: Jorgen Staal Nielsen, Calgary (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Telecommunications Research Laboratories

(21) Appl. No.: 10/799,421

(22) Filed: Mar. 12, 2004

Related U.S. Application Data
(60) Provisional application No. 60/453,947, filed on Mar. 13, 2003.

(51) Int. Cl. H04K 1/00

(52) U.S. Cl. 375/316

(57) ABSTRACT

This disclosure document outlines the concept and description of a Rake receiver with single bit detection processing optimized for the reception of UWB (Ultra_WideBand) signals. The propagation channel estimation required by the Rake receiver is achieved by estimating the probability density function of the single bit quantizer output rather than using a complex analog amplitude estimation which typically requires multi-bit detector quantization and significantly more processing. As only a single quantization bit is used, the quantity of Digital Signal Processing (DSP) operations required per received data bit is drastically reduced. This has advantages in reducing the processing power and cost requirements.

### CROSS-REFERENCE TO RELATED APPLICATIONS

This application claims priority from United States provisional application No. 60/453,947 filed Mar. 13, 2003.

### BACKGROUND OF THE INVENTION

This invention relates to the design of wideband telecommunications transceivers. For ease of reading, the following acronyms and variables will be used.

| | |
|---|---|
| ADC | Analog to Digital Convertor |
| AGC | Automatic Gain Control |
| B(n) | vector of weights for SBR combining |
| CIR | Channel Impulse Response |
| DSP | Digital Signal Processing |
| erfc( ) | Complementary error function |
| H0, H1 | denotes cases for data symbol 0 and data symbol 1 |
| | hypothesis |
| h(n) | discrete impulse response of overall link including tx, rx |
| | and multipath effects. |
| IR | Impulse Radio |
| LNA | Low Noise Amplifier |
| M | number of chips in each symbol |
| M-ary | data modulation with M orthogonal symbols |
| N | number of PPM timing resolution steps per chip epoch |
| N_{b} | number of samples in S/P buffer |
| Nₛ | number of samples in a short burst for each pulse |
| OOK | On Off Keying |
| P(n) | Probability that signal sample r(m, n) > 0 |
| PPM | Pulse Position Modulation |
| PSD | Power Spectral Density |
| Qₛ, Q_{sL}, Q_{sH} | metrics derived from p(n) for pilot tracking |
| rₚ(m, n) | samples for m^{th} pilot pulse and n^{th} delay |
| r_{d1}(m, n) | samples for m^{th} pulse of data 1 symbol and n^{th} delay |
| r_{d0}(m, n) | samples for m^{th} pulse of data 0 symbol and n^{th} delay |
| S_{d0} | matrix of samples for data symbol 0, ie r_{d0}(m, n) |
| S_{d1} | matrix of samples for data symbol 0, ie r_{d1}(m, n) |
| Sₚ | matrix of samples for pilot |
| SNR | Signal to Noise Ratio |
| S/P | Serial to Parallel |
| T | chip epoch |
| Tₛ | basic PPM timing resolution Tₛ = T/N |
| UWB | Ultra Wide Band |
| wₚ(m, n) | noise component of pilot sample for m^{th} pilot pulse at |
| | the n^{th} delay |
| X(n) | sum of column n of the sample matrix |
| Zₚ | SBR output decision variable for OOK pulse presence |
| Z_{b} | SBR output decision variable for 2-ary bit |

UWB uses a transmission bandwidth of about 3.1 to 10.6 GHz and is subject to a strict Power Spectral Density (PSD) requirement imposed by the FCC which limits the EIRP from the transmit antenna to less than −43 dBm/MHz (FCC 02-48, FCC regulation ET docket 98-153, released Feb. 14, 2002). As yet there is no dominant standard for the physical layer technology for UWB however there is some convergence toward an Impulse Radio (IR) implementation where the signal modulation will consist of very narrow pulses that are less than 1 nsec in pulse width resulting in a PSD of the modulated signal that extends over several GHz. (Matthew L Welborn, “System considerations for ultra-wideband wireless networks”, 2001 IEEE Radio and Wireless Conference (RAWCON), August 2001 Boston, Mass. and M. Win, R.Scholtz, “Impulse radio: How it works”,IEEE Communications Letters, Vol.2. No.1. January 1998). As the PSD is very low, the individual pulses representing the data will have very low energy content. Consequently, an UWB symbol will consist of many pulses which are positioned pseudo-randomly in time according to the code word representation.

A format considered here is that the UWB signal will consist of two superimposed pulse train signals. These are a pilot reference signal and an M-ary data signal. The symbol for both the pilot and data is composed of M chip epochs where the individual chip epoch has a duration of T. Hence the basic symbol period is MT. Within each chip epoch of duration T, there are N time slots that the chip pulse can occur. Tₛ is defined as the time resolution of the pulse position as

$${T}_{s} = \frac{T}{N}$$

In the UWB implementation the parameters M and N will typically be several hundred.

The pulse sequences for the pilot and the data symbols are such that there are no overlapping pulses. Hence the data symbol and pilot signal can be considered to be orthogonal and can be superimposed such that they are transmitted simultaneously. As there are N distinct slots within each chip then it is possible to have (N−1) bits per symbol. However, due to multipath spreading of the transmitted pulse the realistic number of orthogonal positions within the chip epoch is much less than N.

A significant factor driving the UWB receiver complexity is the multipath effects that will exist with any typical propagation environment. The UWB modulation will have sufficient bandwidth to resolve multipath clusters. Also the separation of the chip pulses for the superimposed pilot and data signals are such that they do not overlap in the presence of multipath. The rms spreading of the indoor Channel Impulse Response (CIR) is typically 30 to 60 nsec. (Giuseppe Durise, Giovanni Romano, “Simulation Analysis and performance evaluation of an UWB system in indoor multipath channel” 2002 IEEE Conference on Ultra Wideband Systems and Technologies and M. Win, R. Scholtz, “Characterization of Ultra-WideBandwidth Wireless Indoor Channels: A communication-Theoretic View”, IEEE Journal on selected areas in communications, Vol. 20, No.9, December 2002, pp.1613-1627). The multipath channel impulse response that is averaged over many trials has the classical exponential decay characteristic. However, at a particular instant, the channel impulse response consists of typically only 2 or 3 dominant clusters as illustrated in FIG. 1.

If the separation of the pilot and data pulses are not sufficient in each chip epoch then the pulses will interfere which is detrimental to the performance of the data demodulation.

Note that as the UWB pulse widths are typically less than 1 nsec, very little of the chip pulse energy would be captured if a multi-finger Rake like receiver structure is not used. However, to adequately capture the energy of the UWB pulse, it is necessary to use more than 100 taps. As the transmitted pulse has significant PSD content that extends over several GHz commensurate very high signal sampling rates are necessary. Clearly a Rake receiver of such high speed processing complexity is not practical for a consumer grade battery powered hand-held device.

### SUMMARY OF THE INVENTION

In order to obtain manageable high speed processing requirements, it is proposed, according to an aspect of the invention, to use single bit quantization in a Rake receiver. In a further aspect of the invention, a zero threshold comparator at 15 GHz sample rate with reasonable power consumption performance is used in the receiver for the single bit detection. 15 GHz is significant as it is approximately the Nyquist sampling rate of the UWB signal bandwidth. The penalty for the single bit quantization relative to an ideal infinite resolution ADC is about 2 dB. However, as the single bit quantization allows a significant number of Rake taps while maintaining a reasonable power consumption for the high speed detection processing, this loss is easily recovered.

SBR (single bit receiver architecture) is a novel and practical method of implementing an IR UWB receiver with efficient processing. The characteristics of the UWB IR are that there is practically “infinite” bandwidth that can be exploited which aids in reducing the E_{b}/Nₒ required to decode each bit with a target BER. Secondly, the CIR RMS delay spread is many times the sampling interval required to adequately sample the IR link response. Consequently a significant number of Rake fingers is required to capture a reasonable fraction of the pulse energy. The limitation will then be the practical amount of processing that the receiver can apply to each decoded data symbol which in turn limits the practical number of Rake fingers.

As the SBR Rake processing is very efficient, substantially more fingers can be afforded such that a higher fraction of the pulse energy can be captured. This increase in percentage energy capture more than offsets the 2 dB penalty which occurs by using single bit quantization.

Further summary of the invention is found in the detailed description and claims that follow, and the claims are incorporated herein by reference.

### BRIEF DESCRIPTION OF THE DRAWINGS

There will now be described preferred embodiments of the invention, with reference to the figures, by way of illustration, in which figures:

FIG. 1 shows a multipath channel impulse response for an indoor channel;

FIG. 2 is a block diagram of an exemplary SBR architecture and processing according to the invention;

FIG. 3 shows an exemplary sampling method for use in an exemplary embodiment of the invention;

FIG. 4 shows a plot of BER at various SNR for one bit quantification and ideal quantification and M=100;

FIG. 5 shows a plot of BER at various SNR for one bit quantification and ideal quantification and M=1000;

FIG. 6 is a power density plot for various M of a modified p(x(n)=m|H1);

FIG. 7 is a graph showing the probability of obtaining an incorrect SNR; and

FIG. 8 is a plot of <Z> for the two cases where there is signal present H1 and where there is no signal present H0 as a function of p(n).

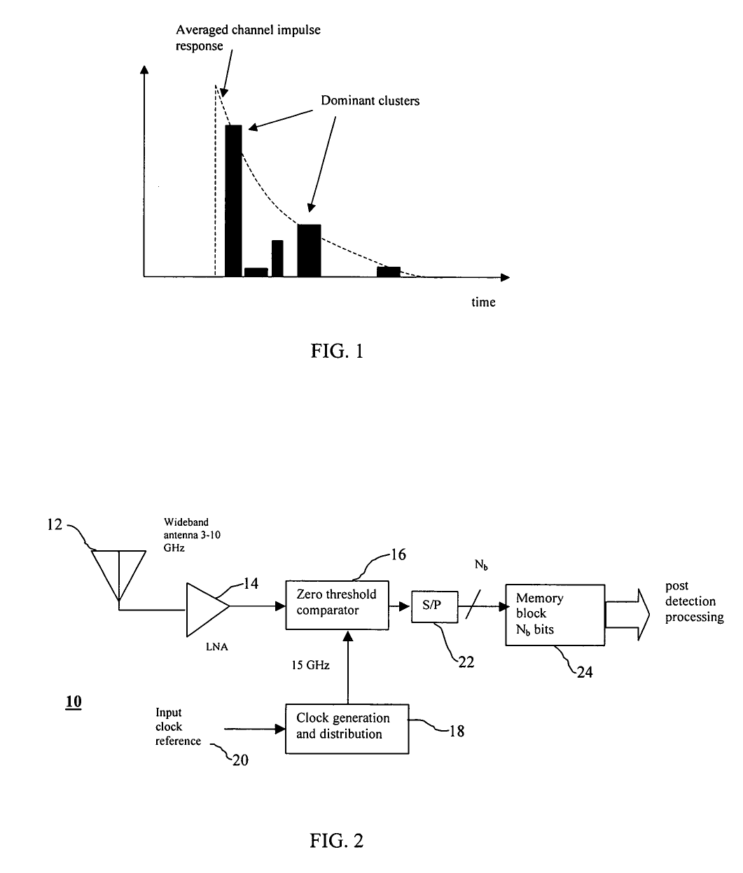

### DETAILED DESCRIPTION OF PREFERRED EMBODIMENTS OF THE INVENTION

A Rake receiver with single bit detection processing is described particularly for the reception of UWB (Ultra_WideBand) signals. The propagation channel estimation required by the Rake receiver is achieved by estimating the probability density function of the single bit quantizer output rather than using a complex analog amplitude estimation which typically requires multi-bit detector quantization and significantly more processing. As only a single quantization bit is used, the quantity of Digital Signal Processing (DSP) operations required per received data bit is drastically reduced. This has advantages in reducing the processing power and cost requirements. Within this document an application of the method is used for an UWB IR (Impulse Radio) receiver. However it is understood that the applications can be significantly broader.

Referring to FIG. 2, the basic SBR architecture 10 comprises an antenna 12, LNA 14, comparator 16, clock generator and synchronizer 18 with clock input 20, serial-parallel converter 22 and memory 24 and is followed by conventional post-detection processing. The comparator 16 is preferably a zero threshold comparator. The Serial to Parallel (S/P) converter 22 has a buffer width of N_{b} such that the following memory buffer 24 can be clocked at the lower speed of 15 GHz/N_{b} cells. The synchronizer 18 and comparator 16 together form a single bit quantizer, while the remaining elements form a Rake receiver with a serial stage and a parallel stage. The single bit quantizer appears on the serial stage.

The antenna 12 is a broad band antenna suitable for signal reception in the UWB band of 3.1 to 10.6 GHz. The LNA 14, which preferably has a fixed gain such that the signal level of the weakest signal pulse anticipated (within the dynamic range requirements), is of sufficient amplitude at the output of the LNA to change states of the zero threshold comparator. Note that a major advantage with zero threshold detection is that no AGC is required.

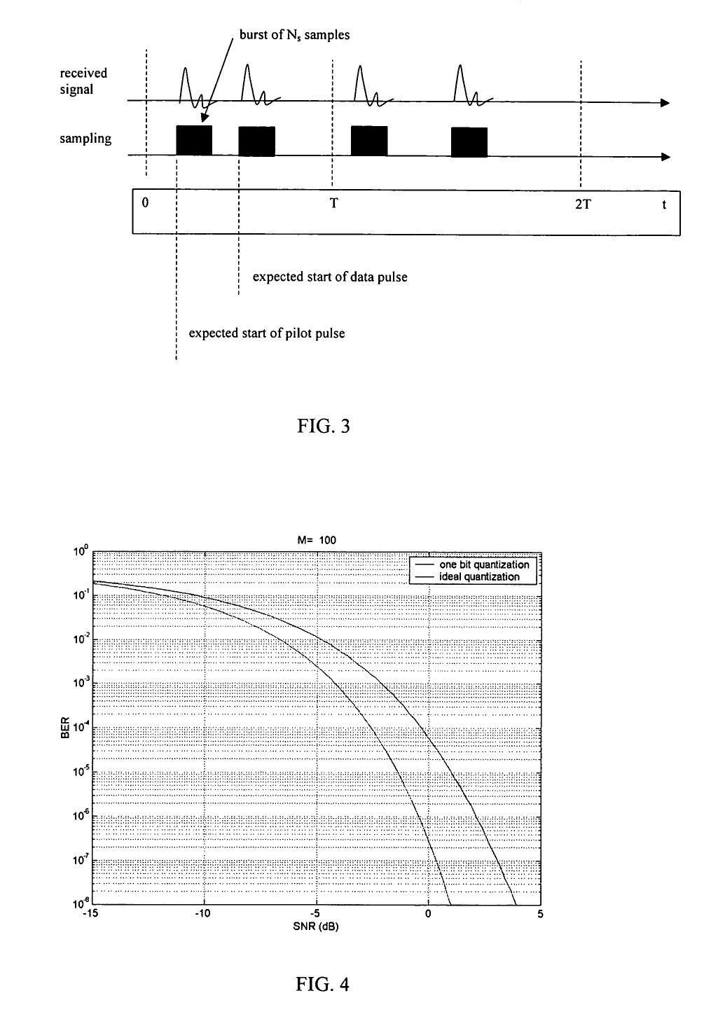

The sampling clock 18 triggers the zero threshold detector 16, generating a binary value “1” if the input analog signal at that instant is greater than zero or “0” if it is less than zero. The binary stream output from the comparator 16 is collected into the memory 24, which may be a circular memory buffer of N_{b} bits. Every cycle of N_{b} samples, the samples are placed on a parallel bus destined for a lower speed DSP processing. To minimize power consumption the sampling is not continuous but in bursts of Nₛ samples every time a pulse is expected where Nₛ is some multiple of N_{b}. This is illustrated in FIG. 3.

A transmitter may be considered to send out a continuous stream of pilot pulses according to a pseudo-random position pattern that the receiver knows as previously described. The synchronizer 18 has time aligned the pulses such that after sampling M pilot pulses there will be a matrix of samples denoted by Sₚ with dimensions M×Nₛ. The matrix entities are denoted as rₚ(m,n) where 0<m<M and 0<n<Nₛ. Hence the time alignment is such that the column of samples n^{th} column of Sₚ refers to samples corresponding to the same delay after the start of the pulse. Similarly there is an M×Nₛ matrix S_{d} which contains the samples for the data symbol. If OOK data modulation is used then there is only a single data symbol to contend with which is either present or not during a given symbol epoch. If 2-ary coding is used then there will be two data matrices denoted as S_{d0} and S_{d1}. In this case 3Nₛ samples are taken every chip period. The samples of S_{d0} and S_{d1} are denoted as r_{d0}(m,n) and r_{d1}(m,n) respectively.

Initially it will be assumed that the receiver 10 is synchronized with the pilot signal emission such that the receiver 10 is in tracking mode as opposed to the initial search mode. In the following section the synchronization will be described.

The sample rₚ(m,n)=Sₚ(m,n) is a binary random variable with discrete values {0,1} and has a PDF of

P(r)=(1−p)δ(r)+pδ(r−1)

Here p is the probability that the signal into the zero threshold comparator is positive such that the binary sample rₚ(m,n)=1.

Note that the pulses are all the same form and amplitude whether they correspond to a pilot or data pulse. Let the signal component of the analog sample of the pulse corresponding to the n^{th} delay be denoted by h(n) which is the impulse response of the overall link including the antennas, channel and any bandpass filter responses convolved with the original transmitter pulse shape. Analog sample implies that signal amplitude prior to quantization. The quantized signal corresponding to the n^{th} delay and the m^{th} chip will have a random noise component of wₚ(m,n). Consequently

$${r}_{p} ( m , n ) = \frac{sign ( h ( n ) + {w}_{p} ( m , n ) ) + 1}{2}$$

Each of the wₚ(m,n) are IID (Independent and Identically Distributed) zero mean gaussian random variables with a variance of σ² reflecting the assumption that the noise affecting the UWB channel is AWGN.

The probability p will be a function of h(n) which we denote as p(n). The probability p(n) is then given by

$$p ( n ) = \frac{1}{2} erfc ( \frac{h ( n )}{\sqrt{2} σ} )$$

Given the pulse sample matrix Sₚ, the probability of a sample of the pulse at the n^{th} delay,

τ(n)=nTₛ

can be estimated by summing the column as

$$p ( n ) \approx \frac{1}{M} {\sum }_{m = 0}^{M - 1} {S}_{p} ( m , n )$$

The probability estimates are continuously updated as the channel impulse response changes with time. Also the number of pilot pulses used per estimate of p(n) is variable as the pilot is generally continuous. The output of the pilot tracking function is then an array of estimated probabilities p(n). As the estimates of p(n) are themselves random variables, it will be necessary to filter these estimates in some fashion. As the channel coherence time is long for indoor channels which is the primary target for UWB communication links, significant averaging is possible resulting in accurate estimates of p(n).

Consider next the set of detected data pulses. As the individual pulses used for the pilot and data are the same, then the probability estimates p(n) can be applied for optimal weighting of the samples of the data symbol. Consider first the OOK case where the single data symbol type is either present or not present. Let H0 denote the hypothesis that a data symbol is not present, and H1 denote the hypothesis that a symbol is present. Hence the conditional probabilities for the single sample r_{d}(m,n) of the S_{d} matrix can then be written as:

$$p ( r \vert H 0 ) = \frac{1}{2} δ ( r ) + \frac{1}{2} δ ( r - 1 )$$

p(r|H1)=p(n)δ(r)+(1−p(n))δ(r−1)

This prompts the following processing. Sum the M comparator samples corresponding to a particular value of n as follows:

$$x ( n ) = {\sum }_{m = 0}^{M - 1} {r}_{d} ( m , n )$$

Note that x(n) has discrete values of {0,1,2 . . . M}. If the noise affecting the SBR is such that the column sums x(n) are statistically independent then a sufficient statistic can be derived for determining if transmitted symbol represents a bit of “0” or a “1”. The overall log likelihood of all the delay offsets is denoted by the test statistic as Z which is given by:

$$Z = {\sum }_{n = 0}^{{N}_{s} - 1} ( M log ( 2 ( 1 - p ( n ) ) + {x}_{n} log ( \frac{p ( n )}{1 - p ( n )} ) )$$

Hence the more positive Z is the more likely that the symbol is present and that the data e is “1”. Likewise the more negative Z is the more likely that the symbol is not present and data value is “0”. Hence the bit decision is:

Choose “1” if Z>0

Choose “0” if Z<0

Note that Z is a linear function of the samples xₙ which is computationally efficient. The processing is simply

Zₚ=A+\vec{B}·\vec{x}

where A is a constant given by

$$A = {\sum }_{n = 0}^{N - 1} M log ( 2 ( 1 - p ( n ) )$$

and the elements of the vector B are given by

$$B ( n ) = log ( \frac{p ( n )}{1 - p ( n )} )$$

and \vec{x} is the vector of xₙ values.

In an M-ary SBR receiver, the signal processing involves measuring the likelihood for the presence or absence of each of the individual symbols. Hence in the 2-ary case, two test statistics are computed:

Z₀—likelihood measure that symbol D0 is present

Z₁—likelihood measure that symbol D1 is present

Where D0 and D1 denote the two symbols in the encoding alphabet. Each symbol consists of M chips as before only with the added requirement that there are no overlapping pulse positions of the symbols which would needlessly reduce the Hamming distance between the symbols.

The bit decision is made in favour of the bit value represented by the symbol with the higher log likelihood. Hence, if Z₀>Z₁ then “0” is decoded. Likewise if Z₁>Z₀ then “1” is decoded. As the A coefficient is the same for both if Z₀ and Z1, the overall test variable for 2-ary reduces to

Z_{b}=Z₁−Z₀=\vec{B}·(\vec{x}₁−\vec{x}₀)

where \vec{x}ᵤ is the vector of column sum's from the detection of symbol u. The role of the vector B now becomes very relevant in two functions:

1. weight the elements of the Rake fingers such that the fingers with the highest power density are given the highest weight

2. rectify the bipolar nature of the channel impulse response

Finally for the general M-ary case, the decision for selecting the u^{th} symbol is that

u→max(\vec{B}·\vec{x}ᵤ)

Note that the B vector is based only on the probability measurements of the pilot and is updated at a slow rate commensurate with the coherence time of the propagation channel.

In this section a simple synchronization scheme will be shown based on the single bit processing. Assuming the sampling interval is Tₛ, then there are N=T/Tₛ, discrete offsets per chip. The linear search span is therefore MN unique offsets. Higher processing gain can be achieved by using multiple cycles of the pilot in the p(n) estimation if required depending on the receiver input SNR.

For the initial synchronization, the receiver will sweep through all the MN offsets sequentially with a delay span of Nₛ samples such that the entire multi-path spread pulse is captured. Hence there are and minimum of MN/Nₛ non-overlapping searches required.

Assume that the matrix Sₚ that was introduced before is loaded with binary samples of the M pilot pulses. As described before, estimate the probabilities p(n) by averaging over the columns of Sₚ, Hence:

$$p ( n ) \approx \frac{1}{M} {\sum }_{m = 1}^{M} {S}_{p} ( m , n ) where 1 < n < {N}_{s}$$

Note that p(n) of around ½ implies that the delay bin contains essentially noise with little signal content. The larger the value of |p(n)−½, the larger the amount of signal content the nth delay bin has. Hence a possible metric for the signal content in the particular span of Nₛ samples is

$${Q}_{s} = {\sum }_{n = 1}^{{N}_{s}} {( p ( n ) - \frac{1}{2} )}^{2}$$

A possible variation is initially removing terms where

$$\vert p ( n ) - \frac{1}{2} \vert < constant$$

In a simple non-overlapping search, there will be N_{search}=NM/Nₛ sequential searches to do. The delay segment that is chosen is the one which has the largest Qₛ value.

After this the receiver goes into a tracking mode with the initial starting point being the highest Qₛ segment. For tracking three metrics are computed:

$${Q}_{sL} = {\sum }_{n = 1}^{{N}_{s} / 2} {( p ( n ) - \frac{1}{2} )}^{2}$$

$${Q}_{sH} = {\sum }_{{N}_{s} / 2 + 1}^{{N}_{s}} {( p ( n ) - \frac{1}{2} )}^{2}$$

Qₛ=Q_{sL}+Q_{sH}

The tracking rules are then:

1. If Q_{sL}>Q_{sH} then the search bin is shifted one sample to the left (decreased delay)

2. If Q_{sL}<Q_{sH} then the search bin is shifted one sample to the right (increased delay)

3. If Q_{sL}=Q_{sH} then the search window remains where it is

4. If Qₛ<constant threshold then tracking is considered lost, and the receiver will make a decision as to dwell longer, go into a reacquisition mode or go into a full search again.

Note also that clock frequency errors can be estimated and tracked by noting the continual shift of the tracking delay window in one or the other direction. Finally it should be noted that there is an opportunity for using the samples collected for the data symbol matrices S_{d}, to enhance the performance of the pilot and tracking and the estimation of the probability vector p(n).

The performance of the SBR can be readily assessed by assuming that the samples w(n,m) for both the pilot and data symbols are zero mean gaussian IID random variables. Actually a large class of possible interfering signals such as will be encountered with the IR can be well approximated as resulting in w(n,m) that are IID zero mean gaussian.

The simplest comparison would be to consider the OOK case with M sampled pulses and compare the BER for the single bit quantizer with the ideal quantizer. Hence a single array of M samples is considered with the sum of the samples given by x. The pdf's P(x|H0) and P(x|H1) were given above. Assuming that H0 and H1 are equally probable, then the probability of error can be evaluated with respect to a threshold denoted by X₀ such that if x>X₀ then H1 is declared and if x<X₀ then H1 is declared. For the OOK case it is easily shown that X₀ is given by

$${X}_{o} = - \frac{M log ( 2 ( 1 - p )}{log ( \frac{p}{1 - p} )}$$

Defining

P0(X₀)=P(x<X₀|H0)

and

P1(X₀)=P(x<X₀|H1)

then the probability of error is evaluated as

$${P}_{er} = \frac{1}{2} ( 1 - P0 ( {X}_{o} ) ) + \frac{1}{2} P1 ( {X}_{o} )$$

The probability p is related to the SNR per sample as

$$p = \frac{1}{2} erfc ( \sqrt{\frac{SNR}{2}} )$$

For the ideal case without quantization error the probability of bit error is given by

$${P}_{er} = \frac{1}{2} erfc ( \sqrt{\frac{M \cdot SNR}{8}} )$$

The extra factor of 4 in the denominator is due to the comparison being for the OOK modulation case such that the Hamming distance is half.

The comparison for the two cases is plotted for various values of M. FIG. 4 shows a plot for M=100

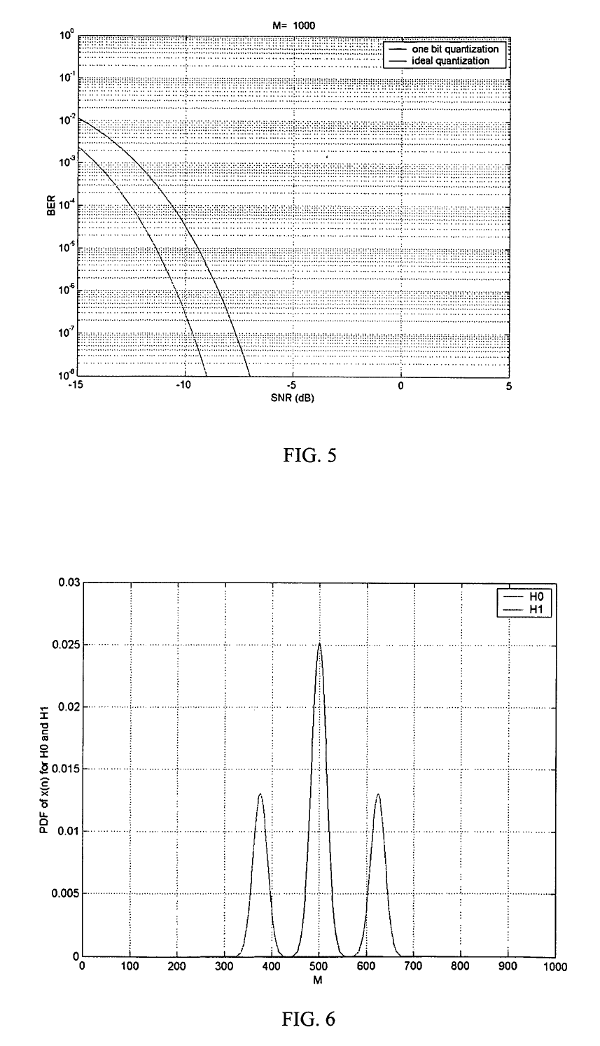

Note for higher SNR's in the region of reasonable symbol error rate, that the ideal quantization is about 2 dB better than the single bit quantization. Here in the region of about 10⁻³ BER, the penalty imposed by the single bit quantization is less than 2 dB consistent with the theoretical derivation in the previous appendix. FIG. 5 shows the plot for M=1000.

As demonstrated here, the performance of the single bit quantization is consistently 2 dB worse than the ideal quantization.

As previously mentioned, the CIR delay spread is significant for indoor propagation resulting in the performance of the receiver being limited by the amount of energy that can be captured from the CIR. The limitation is due to finite high speed processing capability of the radio at the 1/tₛ sampling rate. Consequently, a different perspective is considered.

Assume the computational case for M and Ns where the SBR with single bit quantization is compared with a D bit quantizer. For the SBR, a counter is used for each delay offset that is incremented if the single bit threshold sample is greater than zero with no operation if the sample is less than zero. The size of the counter has to be log2(M) bits. As the sample is greater than zero half the time, the average number of bit operations is log2(M)/2. Consequently for the complete symbol correlation there are

$$\frac{MN}{2} {log}_{2} ( M )$$

total bit operations. Next consider an ADC with D bits of quantization. A full adder of D+log2(M) bits is required that is used MN times. Assuming that the ADC output bits have a probability of being zero half the time then the approximate number of bit operations is

3MN/2(D+log₂(M))

Consequently, with a typical ADC, a rough value of 4 times the number of bit operations are required relative to the SBR processing. Consequently for the same quantity of high speed bit operations, the number of fingers in the SBR can be about 4 times the number of bit operations with the Rake using a multi-bit ADC. Assuming that the CIR delay spread is sufficiently long, then for equivalent amount of processing, the SBR can capture 4 times the amount of energy compared to the conventional Rake. Hence the input SNR requirements of the SBR will be less than the SNR of the conventional Rake by an amount of about 10log(4)−2=4dB where the 2 dB is the penalty of using single bit quantization versus multi-bit.

The above simplistic comparison did not include the implications of implementing a very high speed ADC as opposed to a simple threshold detector. If the threshold detector is equivalent to a single bit operation per sample and the D bit flash ADC is equivalent to at least 2 D binary operations then the ratio of bit operations for a given M and N is much larger being

$$\frac{MN ( \frac{3}{2} ( D + {log}_{2} ( M ) ) + {2}^{D} )}{MN ( \frac{1}{2} {log}_{2} ( M ) + 1 )} \approx {2}^{D}$$

Consequently the performance advantage of the SBR relative to a conventional Rake receiver can be enormous.

In the pilot search, each time delay offset must be tested to verify the presence or absence of a pilot signal. Consider the case where the dwell time for testing a particular offset is M chips. For the present, ignore the possibility of using decision feedback data pulses to augment the search for the pilot.

For sake of simplicity consider the consider the analysis for no multipath such that only one column out of MN will contain the pilot signal. The other MN−1 columns will contain only noise. After the sampling, the x(n) column sums are formed. If the n^{th} delay offset contains mainly noise, then x(n) will be approximately close to the mean of M/2. Hence the likelihood that the pilot corresponds to a certain delay offset is a monotonically increasing function of z(n) given by

z(n)=|x(n)−½|

The pilot offset is declared by the index n corresponding to the largest value of z(n). The simplest way of evaluating the probability of selecting the wrong column is to first modify the pdf of x(n) to reflect the absolute value as

$$p ( x ( n ) = m \vert H1 ) = \frac{1}{2} ( \begin{matrix}M \\ m\end{matrix} ) ( {p ( n )}^{M - m} {( 1 - p )}^{m} + {p ( n )}^{m} {( 1 - p )}^{M - m} )$$

and p(x(n)=m|H0) stays the same as before. A plot of the modified p(x(n)=m|H1) pdf if given in FIG. 6. These pdf's correspond to the case where SNR per chip sample is −10 dB and M=1000.

Next determine the probability of z(n) corresponding to a column containing the pilot al (ie use the H1 pdf) compared to z(k) corresponding to a column containing noise only (ie the H0 pdf). Hence

$$Pr ( z ( n ) > z ( k ) ) = {\sum }_{m = 0}^{M} p ( x ( n ) = m \vert H1 ) {\sum }_{q = 0}^{m - 1} p ( x ( k ) = q \vert H0 )$$

Finally the probability of selecting the wrong delay offset n is

Pₑ=1−[Pr(z(n)>z(k))]^{N-1}

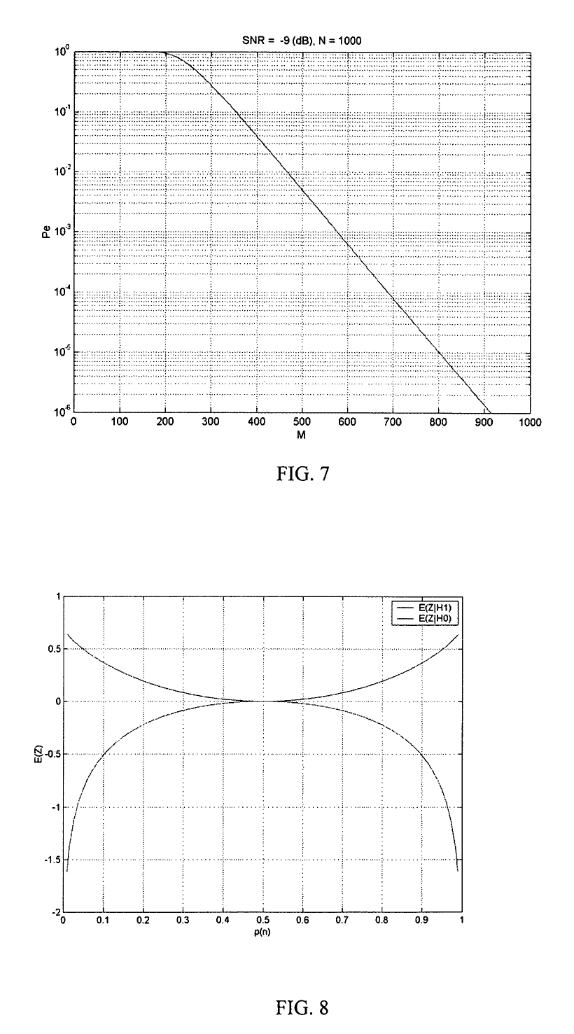

A plot of Pₑ is given in FIG. 7.

As demonstrated, the statistical properties of the pilot operation are reasonable for practical usage.

Derivation of test statistic: Assume that samples r(m,n) have been taken and stored in an MxN matrix S with 1<m<M and 1<n<N as described in the text. Recall that m is the index the chips and n is the delay index of samples after the start of the pulse. As described in foregoing text, the column sums of S, x(n) are evaluated as

$$x ( n ) = {\sum }_{m = 1}^{M} r ( m , n )$$

Furthermore define the vector of column sums as

\vec{x}={x₁,x₂ . . . x_{N}}

Consider the case where a test statistic is required that reflects the choice between two hypothesis:

H0: no signal is present such that the samples r(m,n) are a result of noise only

H1: signal and noise are present

From the Neyman Pearson theorem the lowest probability of error is attained if the decision is made in favour of H1 if

P(\vec{x}|H1)>P(\vec{x}|H0)

and likewise if

P(\vec{x}|H1)<P(\vec{x}|H0)

then H0 is selected. The overall test statistic is then logically defined as

$$Z = log ( \frac{P ( {x}^{->} \vert H1 )}{P ( {x}^{->} \vert H0 )} )$$

such that H1 is selected if Z>0 and H0 is selected if Z<0.

The Neyman Pearson test is optimal for any condition joint probability of x. As the UWB receiver has a bandwidth commensurate with the sampling rate, 1/Tₛ it is reasonable to consider the noise contained in each column sum x(n) to be independent. However, if the noise is colored in some way x(n) will not be jointly independent. Deriving the optimal test statistic for such a case becomes very tedious. In this case statistical independence of x(n) will be assumed which makes the test statistic Z linear and very easy to implement. However, the test statistic will be sub-optimal unless the input noise corrupting the samples r(m,n) is not AWGN.

Assuming independence of x(n) then Z can be written as

$$Z = {\sum }_{n = 0}^{N - 1} log ( \frac{P ( {x}_{n} \vert H1 )}{P ( {x}_{n} \vert H0 )} )$$

Note that x(n) has discrete values of {0,1,2 . . . M}. The probability distribution for x(n) given H0 or H1 is given as:

$$p ( x ( n ) = m \vert H0 ) = ( \begin{matrix}M \\ m\end{matrix} ) {2}^{- M}$$

$$p ( x ( n ) = m \vert H1 ) = ( \begin{matrix}M \\ m\end{matrix} ) {p ( n )}^{m} {( 1 - p )}^{M - m}$$

Consequently the n^{th} term in the sum for Z is

$$log ( \frac{( \begin{matrix}M \\ {x}_{n}\end{matrix} ) {p ( n )}^{{x}_{n}} {( 1 - p ( n ) )}^{M - {x}_{n}}}{( \begin{matrix}M \\ {x}_{n}\end{matrix} ) {( \frac{1}{2} )}^{M}} ) = log ( {2}^{M} {p ( n )}^{{x}_{n}} {( 1 - p )}^{M - {x}_{n}} )$$

Consequently

$$Z = {\sum }_{n = 0}^{N - 1} M log ( 2 ( 1 - p ( n ) ) + {x}_{n} log ( \frac{p ( n )}{1 - p ( n )} )$$

Note that Z is a linear function of the samples xₙ which is computationally efficient. The processing is simply

Z=A+\vec{B}\vec{x}

where A is a constant given by

$$A = {\sum }_{n = 0}^{N - 1} M log ( 2 ( 1 - p ( n ) )$$

and the elements of the vector B are given by

$$B ( n ) = log ( \frac{p ( n )}{1 - p ( n )} )$$

From the pilot tracking the p(n) values are determined from which the coefficients A, B(0),B(1), . . . B(N−1) can be derived. The scaler A and vector B are updated as the channel changes. The coherence time of these parameters will be on the order of the coherence time of the indoor channel which is typically around 0.1 seconds.

Note that the coefficients, B(n), have the function of weighting coefficients. When the nth bin has very little signal content such that p(n) approaches 0.5, then B(n) approaches zero. For high SNR in the nth bin such that |p(n)−0.51 approaches ½ then |B(n)| becomes large resulting in a large weight for xₙ. Consider the expected value of Z which is

$$⟨ Z ⟩ = {\sum }_{n = 0}^{N - 1} M log ( 2 ( 1 - p ( n ) ) + ⟨ {x}_{n} ⟩ log ( \frac{p ( n )}{1 - p ( n )} )$$

which becomes

$$⟨ Z ⟩ = {\sum }_{n = 0}^{N - 1} M ( log ( 2 ( 1 - p ( n ) ) + p ( n ) log ( \frac{p ( n )}{1 - p ( n )} ) )$$

which reduces to the relation

$$⟨ Z ⟩ = {\sum }_{n = 0}^{N - 1} M ( log ( 2 {( 1 - p ( n ) )}^{( 1 - p ( n ) )} {p ( n )}^{p ( n )} )$$

which shows the symmetry around p(n)=½. <Z> is plotted in FIG. 8 for the two cases where there is signal present H1 and where there is no signal present H0 as a function of p(n). For this plot M=1 and N=1.

Note that <Z|H1> is always greater than 0 and <Z|H0> is always less than zero regardless of the value of p(n). Note also that as p(n) approaches ½, <Z> tends toward 0 as the H1 and H0 case become indistinguishable.

Immaterial modifications may be made to the exemplary embodiment of the invention described here without departing from the invention.

What is claimed is:

1. A telecommunications apparatus, comprising:
a multi-finger Rake receiver having a serial stage and a parallel stage; and
a single bit quantizer on the serial stage.

2. The telecommunications apparatus of claim 1 in which:
parallel branches of the Rake receiver are weighted;
pulse samples from the single bit quantizer have estimated probabilities corresponding to different delays; and the weighting factors used in the Rake receiver are derived from the estimated probabilities of the corresponding pulse samples.

3. The telecommunications apparatus of claim 2 in which the weighting factors are derived from a ratio of the estimated probability of a corresponding sample at the nth delay and the estimated probability that there is not a corresponding sample at the nth delay.

4. The telecommunications apparatus of claim 1 used with on off keying encoding/modulation scheme.

5. The telecommunications apparatus of claim 1 in which the single bit quantizer uses a decision statistic summed over samples of a received signal to determine whether a symbol is present.

6. The telecommunications apparatus of claim 5 in which the decision statistic uses a sum of a constant plus a function that depends on estimated probabilities of samples of the received signal being greater or less than a threshold.

7. The telecommunications apparatus of claim 1 used with a 2-ary encoding/modulation scheme.

8. The telecommunications apparatus of claim 7 in which the single bit quantizer analyzes a weighted sum of samples from a received signal to determine whether a symbol has been received.

9. The telecommunications apparatus of claim 1 used with a M-ary encoding/modulation scheme.

10. The telecommunications apparatus of claim 9 in which the single bit quantizer determines presence of a symbol in a received signal based on a maximum weighted sum of samples of a received signal.

11. The telecommunications apparatus of claim 1 in which the single bit quantizer operates using a search bin to determine presence of a symbol in a received signal, and shifts a search bin based on the estimated probability of a corresponding sample at the nth delay.

12. The telecommunications apparatus of claim 11, in which the single bit quantizer uses a clock synchronizing scheme using metrics with a set of tracking rules, where the metrics are based on a sum of magnitudes of a set of samples of the estimated probability of a corresponding sample at the nth delay.

13. The telecommunications apparatus of claim 12 in which the tracking rules are:
If Q_{sL}>Q_{sH} then the search bin is shifted to the left, corresponding to decreased delay;
If Q_{sL}<Q_{sH} then the search bin is shifted to the right, corresponding to increased delay;
If Q_{sL}=Q_{sH} then the search bin is not shifted; and
If Qₛ<a constant threshold then tracking is considered lost, and the single bit quantizer chooses between extending the search, reacquisition of a signal or repeating a search; and in which Q_{sL} is based on the sum across a first portion of the set of samples, and Q_{sH} is based on the sum across a second portion of the set of samples, and Qₛ is the sum across both portions of the set of samples.

14. The telecommunications apparatus of claim 1 in which pilot tracking data used for deciding whether a sample represents a symbol 1 or not is used with decision feedback data samples from samples of a received signal.

15. The telecommunications apparatus of claim 1 in which the receiver uses a single bit quantized pilot signal to estimate propagation channel characteristics, whereby weighting coefficients may be derived for the Rake receiver by operating on received data samples.
